(19) United States
(12) Patent Application Publication
(10) Pub. No.: US 2014/0092831 A1
(43) Pub. Date: Apr. 3, 2014

(54) WIRELESS TERMINAL DEVICE, RECORDING MEDIUM, AND CONTROL METHOD

(71) Applicant: Fujitsu Mobile Communications Limited, Kawasaki-shi (JP)

(72) Inventor: Naritoshi SAITO, Hino (JP)

(21) Appl. No.: 13/939,073

(22) Filed: Jul. 10, 2013

(30) Foreign Application Priority Data
Sep. 28, 2012 (JP) 2012-218080

(51) Int. Cl. H04W 52/24

(52) U.S. Cl. CPC H04W 52/243
USPC 370/329

(57) ABSTRACT

CPU in a multi-wireless terminal, that allows simultaneous wireless communication for communication of a 1x system and communication of an LTE system, executes a process of monitoring a protocol state for the communication of the 1x system. When the protocol state for the communication of the 1x system is during transmission, the CPU executes a process of performing maximum value control for limiting a maximum value of transmission power for the communication of the LTE system. Moreover, when the protocol state for the communication of the 1x system is any state other than during the transmission, for example, during idle or during position registration operation, the CPU executes a process of stopping the maximum value control.

### CROSS-REFERENCE TO RELATED APPLICATION

This application is based upon and claims the benefit of priority of the prior Japanese Patent Application No. 2012-218080, filed on Sep. 28, 2012, the entire contents of which are incorporated herein by reference.

### FIELD

The embodiments discussed herein are related to a wireless terminal device, a recording medium, and a control method.

### BACKGROUND

Recently, as a third generation mobile communication system (3G), various communication systems such as Code Division Multiple Access (CDMA) 2000, CDMA 2000 1x, and CDMA 2000 1xEV-DO (Evolution-Data Only) are proposed. The CDMA 2000 1x is one of technical specifications included in CDMA 2000 standard, and is hereinafter called “1x”. The CDMA 2000 1xEV-DO is a standard in which a 1x system is improved to be specialized in data communication and its transmission speed is increased, and is hereinafter called “EV-DO”.

As a wireless communication standard for mobile phones, various data communication systems such as Long-Term Evolution (LTE) and a fixed wireless communication standard (WiMAX (™): Worldwide Interoperability for Microwave Access) are proposed.

For example, the 1x system and an EV-DO system are widely used services in recent years, and therefore a large number of base stations are located to cover a widespread communication area. On the other hand, an LTE system and a WiMAX system are new services as compared with the 1x system, and therefore these systems cover narrow communication areas around urban areas included in the communication areas of the 1x system and the EV-DO system.

Under these circumstances, as wireless terminals such as mobile phones, multi-wireless terminals capable of performing communications using a plurality communication systems such as the 1x system, the EV-DO system, and the LTE system are provided. The multi-wireless terminal can select, according to an user operation, a communication mode in which voice communication and packet communication are simultaneously performed using, for example, both the 1x system and the LTE system or a communication mode in which packet communication is performed using, for example, only the LTE system.

The wireless terminal has a known maximum control function for limiting a maximum value of transmission power for a wireless unit based on Specific Absorption Rate (SAR) specifications in which a reference value of electromagnetic waves allowable to human body is specified. For example, when simultaneously transmitting power to a 1x base station and an LTE base station, the multi-wireless terminal monitors a 1x transmission power value for the wireless unit of the 1x system. Moreover, the multi-wireless terminal sets a transmission power maximum value for a wireless unit of the LTE system i.e. an LTE transmission power maximum value based on the 1x transmission power value. The multi-wireless terminal then limits the transmission power value for the wireless unit of the LTE system based on the LTE transmission power maximum value.

That is, the multi-wireless terminal uniformly sets the LTE transmission power maximum value regardless of a current protocol state for the communication of the 1x system, and limits the transmission power value for the wireless unit of the LTE system based on the set LTE transmission power maximum value.
Patent Literature 1: Japanese Laid-open Patent Publication No. 2010-98612
Patent Literature 2: Japanese Laid-open Patent Publication No. 2002-94392
Patent Literature 3: Japanese Laid-open Patent Publication No. 2011-77996
Patent Literature 4: Japanese Laid-open Patent Publication No. 2010-119028

For example, when the protocol state for the communication of the 1x system is a state during idle or during position registration operation, this state is shorter as compared with a time required during traffic channel (TCH) transmission (during voice communication). However, SAR standard (ARIB STD-T56: Indices to protect the body upon use of radiowaves) in Japan does not require maximum value control for limiting the transmission power value for the wireless unit of the LTE system when the protocol state for the communication of the 1x system is a state during idle or during position registration operation.

However, even when the protocol state of the 1x system is a state during idle or during position registration operation, the multi-wireless terminal uniformly limits the transmission power value for the wireless unit of the LTE system. As a result, in the multi-wireless terminal, the transmission power value of the LTE system becomes small and the data cannot therefore reach the base station, which leads to a decrease in a communication throughput.

The SAR specifications differ in each country. In addition, the multi-wireless terminal of global specifications complies with the SAR specifications of a destination country with the most strict SAR reference value among all destination countries, and sets an LTE transmission power maximum value based on the SAR specifications. However, in the multi-wireless terminal based on the SAR specifications of the destination country with the most strict SAR reference value, even when this multi-wireless terminal is used in a country with lax SAR specifications, the LTE transmission power maximum value becomes small, which leads to a decrease in a communication throughput of the LTE system.

### SUMMARY

According to an aspect of an embodiment, a wireless terminal device allows simultaneous wireless communication for communication of a first communication system and communication of a second communication system. The wireless terminal device includes a memory and a processor coupled to the memory. The processor performs a process including: monitoring a protocol state for the communication of the first communication system; performing maximum value control for limiting a maximum value of transmission power for the communication of the second communication system when the protocol state for the communication of the first communication system is during transmission; and stopping the maximum value control when the protocol state for the communication of the first communication system is any state other than during the transmission.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a multi-wireless terminal according to a first embodiment;

FIG. 2 is an explanatory diagram illustrating an example of a relationship between a communication area of a 1x/EV-DO system and a communication area of an LTE system;

FIG. 3 is an explanatory diagram illustrating examples of a 1x device, an LTE device, and a CPU in the multi-wireless terminal according to the first embodiment;

FIG. 4 is an explanatory diagram illustrating contents of a 1x TCH flag;

FIG. 5 is an explanatory diagram illustrating an example of a conversion table;

FIG. 6 is an explanatory diagram illustrating an example of the 1x device;

FIG. 7 is an explanatory diagram illustrating an example of a correspondence in a 1x conversion table;

FIG. 8 is an explanatory diagram illustrating an example of the LTE device;

FIG. 9 is an explanatory diagram illustrating an example of an LTE conversion table;

FIG. 10 is a flowchart illustrating an example of a processing operation of the CPU in the multi-wireless terminal related to a TCH flag setting process;

FIG. 11 is a flowchart illustrating an example of a processing operation of the CPU in the multi-wireless terminal related to a first SAR control process;

FIG. 12 is an explanatory diagram illustrating examples of the 1x device, the LTE device, and the CPU in a multi-wireless terminal according to a second embodiment;

FIG. 13 is an explanatory diagram illustrating an example of a country-specific setting table;

FIG. 14A is an explanatory diagram illustrating an example of a conversion table “A”;

FIG. 14B is an explanatory diagram illustrating an example of a conversion table “B”;

FIG. 15 is an explanatory diagram illustrating an example of a PLMN code;

FIG. 16 is a flowchart illustrating an example of a processing operation of an LTE baseband processor in the multi-wireless terminal related to an MCC acquiring process;

FIG. 17 is a flowchart illustrating an example of a processing operation of the CPU in the multi-wireless terminal related to a second SAR control process;

FIG. 18 is an explanatory diagram illustrating an example of a country-specific/business entity-specific setting table; and

FIG. 19 is an explanatory diagram illustrating a wireless terminal device that executes a control program.

### DESCRIPTION OF EMBODIMENTS

Preferred embodiments of the present invention will be explained with reference to accompanying drawings. The disclosed technology is not limited to the embodiments. In addition, the embodiments explained below may be combined with each other as appropriate within a scope with no conflict.

### [a] First Embodiment

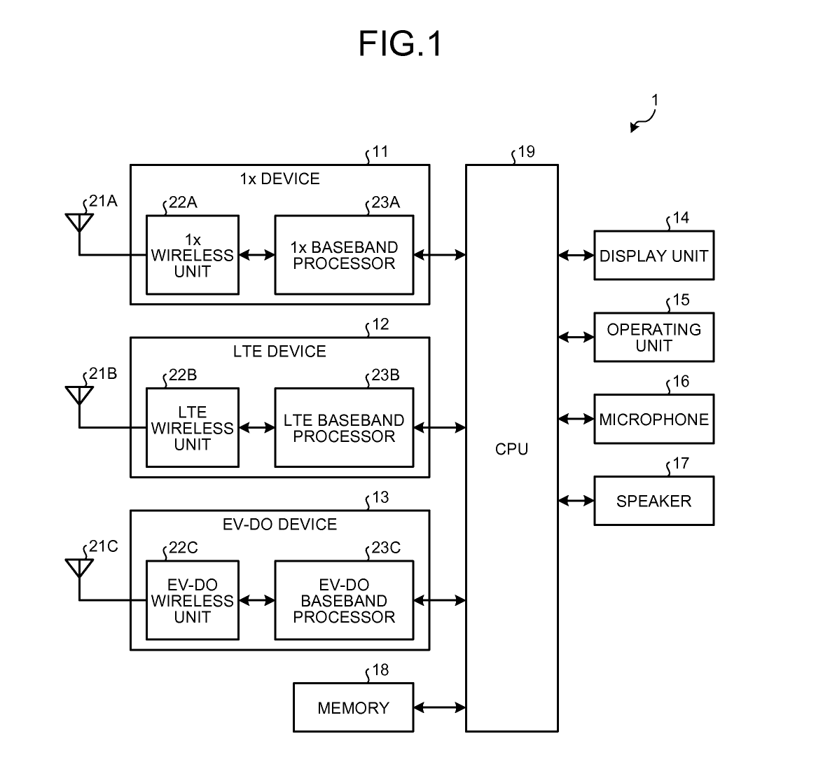

FIG. 1 is an explanatory diagram illustrating an example of a multi-wireless terminal according to a first embodiment. A multi-wireless terminal 1 illustrated in FIG. 1 includes a 1x device 11, an EV-DO device 13, an LTE device 12, a display unit 14, an operating unit 15, a microphone 16, a speaker 17, a memory 18, and a Central Processing Unit (CPU) 19.

The 1x device 11 is an interface that controls wireless communication of the 1x system as a first communication system. The 1x device 11 includes an antenna 21A, a 1x wireless unit 22A, and a 1x baseband processor 23A. The 1x wireless unit 22A receives a wireless signal of various data such as sound and text based on the 1x system via the antenna 21A, and frequency-converts the received signal. The 1x baseband processor 23A converts the signal frequency-converted by the 1x wireless unit 22A to a baseband signal, converts the converted baseband signal to a digital signal, and demodulates a digitally converted baseband signal. The 1x baseband processor 23A modulates transmission data to a baseband signal and converts the modulated baseband signal to an analog signal. The 1x wireless unit 22A frequency-converts the baseband signal sent from the 1x baseband processor 23A and outputs the frequency-converted transmission signal via the antenna 21A.

The EV-DO device 13 is an interface that controls wireless communication of the EV-DO system. The EV-DO device 13 includes an antenna 21C, an EV-DO wireless unit 22C, and an EV-DO baseband processor 23C. The EV-DO wireless unit 22C receives a wireless signal of various data such as sound and text based on the EV-DO system via the antenna 21C, and frequency-converts the received signal. The EV-DO baseband processor 23C converts the signal frequency-converted by the EV-DO wireless unit 22C to a baseband signal, converts the converted baseband signal to a digital signal, and demodulates a digitally converted baseband signal. The EV-DO baseband processor 23C modulates transmission data to a baseband signal and converts the modulated baseband signal to an analog signal. The EV-DO wireless unit 22C frequency-converts the baseband signal sent from the EV-DO baseband processor 23C and outputs the frequency-converted transmission signal via the antenna 21C.

The LTE device 12 is an interface that controls wireless communication of the LTE system as a second communication system. The LTE device 12 includes an antenna 21B, an LTE wireless unit 22B, and an LTE baseband processor 23B. The LTE wireless unit 22B receives a wireless signal of various data such as sound and text based on the LTE system via the antenna 21B, and frequency-converts the received signal. The LTE baseband processor 23B converts the signal frequency-converted by the LTE wireless unit 22B to a baseband signal, converts the converted baseband signal to a digital signal, and demodulates a digitally converted baseband signal. The LTE baseband processor 23B modulates transmission data to a baseband signal and converts the modulated baseband signal to an analog signal. The LTE wireless unit 22B frequency-converts the baseband signal sent from the LTE baseband processor 23B and outputs the frequency-converted transmission signal via the antenna 21B.

The display unit 14 is an output interface that displays various types of information on a screen. The operating unit 15 is an input interface that inputs various types of information. The microphone 16 is an input interface that picks up various types of sounds. The speaker 17 is an output interface that acoustically outputs various types of sounds. The memory 18 is an area where various types of information are stored. The CPU 19 controls the entire multi-wireless terminal 1.

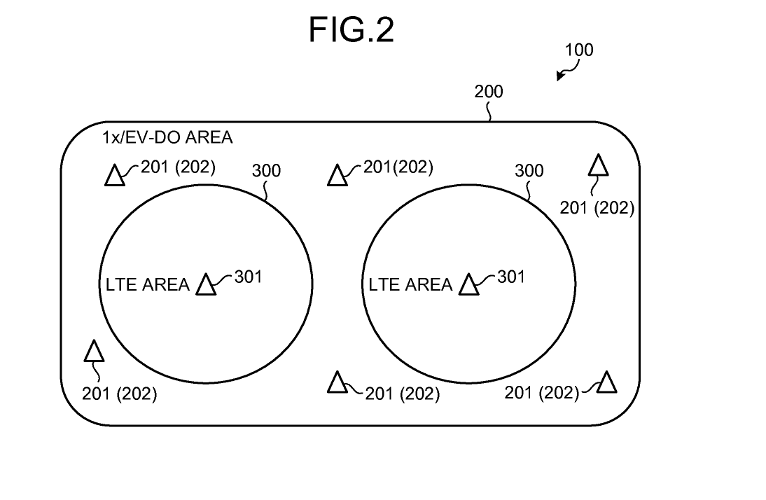

FIG. 2 is an explanatory diagram illustrating an example of a relationship between a communication area of a 1x/EV-DO system and a communication area of an LTE system. A wireless network 100 illustrated in FIG. 2 includes a 1x/EV-DO communication area 200 and an LTE communication area 300. The 1x/EV-DO communication area 200 is a communication area of widely distributed service in recent years. The 1x/EV-DO communication area 200 provides voice service and packet service. The LTE communication area 300 is newer service as compared with 1x/EV-DO communication, and provides packet service around densely populated cities. The LTE communication area 300 provides high-speed packet service. Therefore, the LTE communication area 300 is narrower as compared with the 1x/EV-DO communication area 200. A plurality of 1x base stations 201 and EV-DO base stations 202 are provided in the 1x/EV-DO communication area 200. A plurality of LTE base stations 301 are provided in the LTE communication area 300. The multi-wireless terminal 1 may perform simultaneous wireless communication with, for example, the 1x base station 201 and the LTE base station 301.

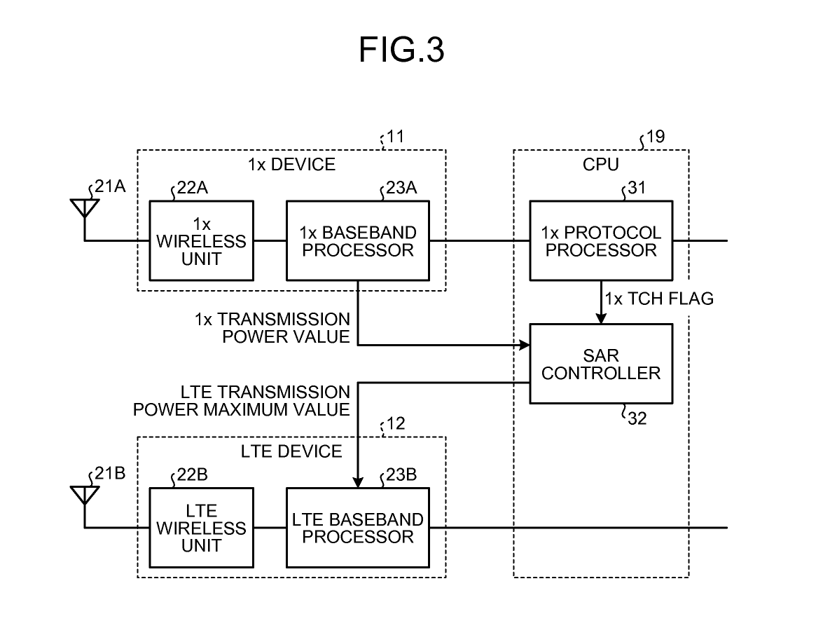

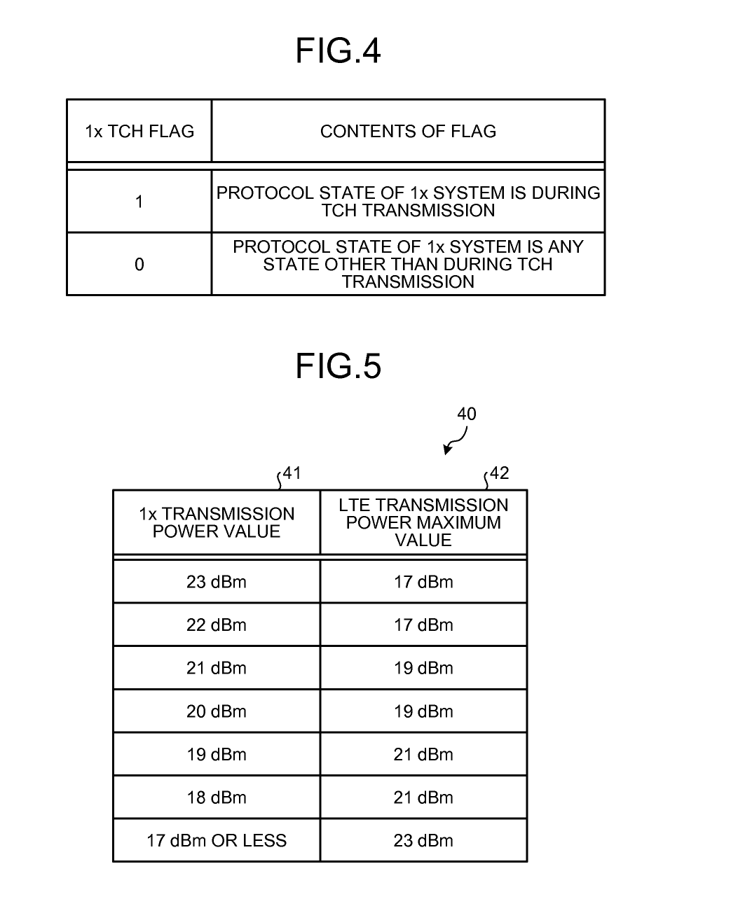

FIG. 3 is an explanatory diagram illustrating examples of the 1x device 11, the LTE device 12, and the CPU 19 in the multi-wireless terminal 1 according to the first embodiment. The CPU 19 illustrated in FIG. 3 includes a 1x protocol processor 31 and an SAR controller 32. The CPU 19 reads a monitoring program (not illustrated) stored in the memory 18, and executes a monitoring process corresponding to the read monitoring program to function as the 1x protocol processor 31. The 1x protocol processor 31 monitors a protocol state of the 1x communication, for example, a state during TCH transmission and an idle state or a state during position registration operation other than the state during the TCH transmission. When a current protocol state of the 1x communication is during the TCH transmission, the 1x protocol processor 31 sets a TCH flag to “1”. When the current protocol state is any state other than during the TCH transmission, the 1x protocol processor 31 sets the TCH flag to “0”. FIG. 4 is an explanatory diagram illustrating contents of a 1x TCH flag. When the 1x TCH flag is “1”, this indicates that the protocol state of the 1x communication is during the TCH transmission. When the 1x TCH flag is “0”, this indicates that the protocol state of the 1x communication is any state other than during the TCH transmission.

The CPU 19 reads a control program (not illustrated) stored in the memory 18, and executes a control process corresponding to the read control program to function as the SAR controller 32. The SAR controller 32 reads an LTE transmission power maximum value corresponding to the 1x transmission power value from the 1x baseband processor 23A, and sets the read LTE transmission power maximum value in the LTE baseband processor 23B of the LTE device 12.

FIG. 5 is an explanatory diagram illustrating an example of a conversion table 40. The conversion table 40 illustrated in FIG. 5 stores therein an LTE transmission power maximum value 42 corresponding to a 1x transmission power value 41. The conversion table 40 is assumed to be stored in, for example, the memory 18. When the 1x TCH flag is “1”, the SAR controller 32 refers to the conversion table 40 in FIG. 5 to read the LTE transmission power maximum value 42 corresponding to the 1x transmission power value 41 and sets the read LTE transmission power maximum value 42 in the LTE baseband processor 23B. The SAR controller 32 performs maximum value control for limiting an LTE transmission power value in the LTE baseband processor 23B based on the set LTE transmission power maximum value. When the 1x TCH flag is “0”, the SAR controller 32 stops the maximum value control.

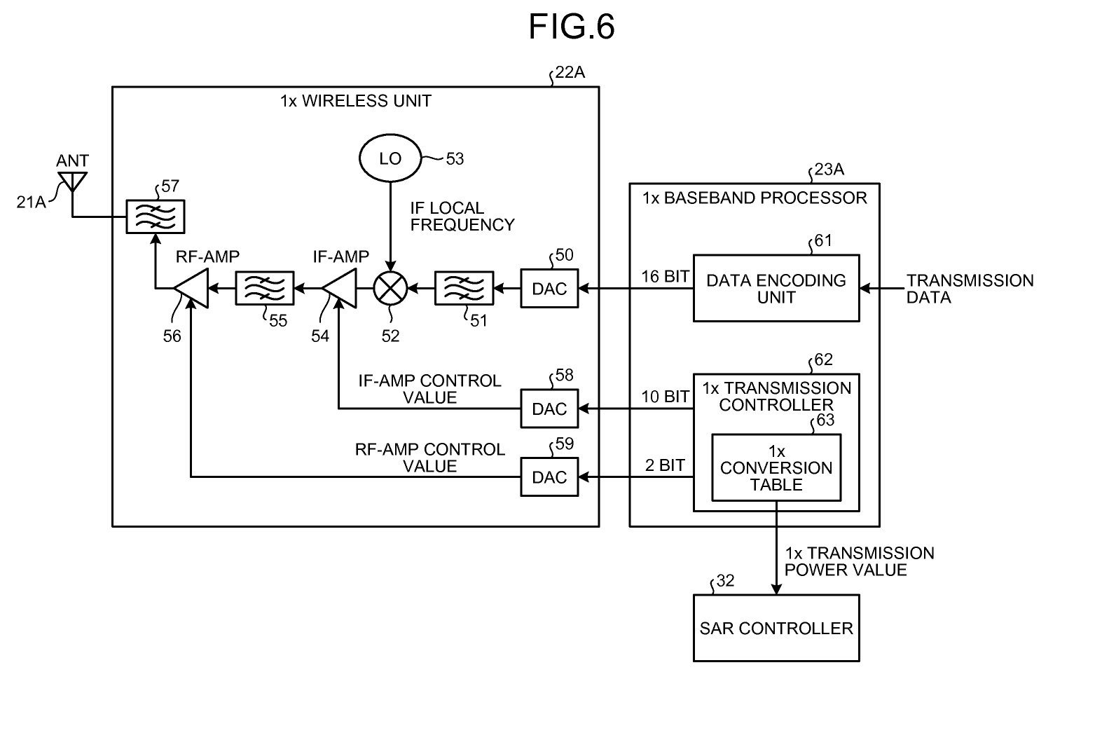

FIG. 6 is an explanatory diagram illustrating an example of the 1x device 11. The 1x device 11 illustrated in FIG. 6 includes the 1x wireless unit 22A and the 1x baseband processor 23A provided on the transmission side. The 1x wireless unit 22A includes a first Digital-to-Analog Converter (DAC) 50, a first filter 51, a mixer 52, a local oscillator 53, an Intermediate Frequency (IF) amplifier (AMP) 54, a second filter 55, and a Radio Frequency (RF) AMP 56. The 1x wireless unit 22A also includes a third filter 57, a second DAC 58, and a third DAC 59.

The first DAC 50 converts encoded transmission data to an analog signal. The first filter 51 performs a filtering process on a baseband signal being the analog-converted transmission signal. The mixer 52 generates an IF signal obtained by mixing the baseband signal on which the filtering process is performed and a carrier frequency sent from the local oscillator 53. The IF-AMP 54 amplifies the generated IF signal. The second filter 55 performs a filtering process on the IF signal amplified by the IF-AMP 54. The RF-AMP 56 amplifies the RF signal of the IF signal on which the filtering process is performed. The third filter 57 performs a filtering process on the RF signal. The antenna 21A outputs the RF signal on which the filtering process is performed.

The 1x baseband processor 23A includes a data encoding unit 61 that encodes transmission data and a 1x transmission controller 62 that controls transmission power of the 1x wireless unit 22A. The 1x transmission controller 62 includes a 1x conversion table 63, and refers to the 1x conversion table 63 to control gains of the IF-AMP 54 and the RF-AMP 56 in the 1x wireless unit 22A, and thereby controls the transmission power for the 1x wireless unit 22A. The 1x transmission controller 62 acquires a 1x transmission power value to be set, and acquires a control value (10-bit IF-AMP control value) of the IF-AMP 54 corresponding to the 1x transmission power value and a control value (2-bit RF-AMP control value) of the RF-AMP 56 from the 1x conversion table 63.

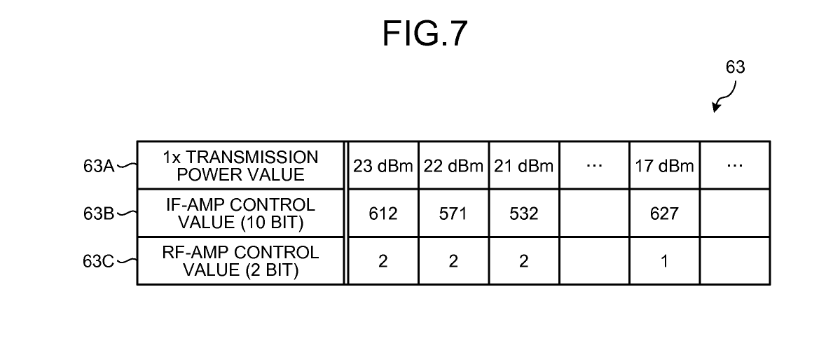

FIG. 7 is an explanatory diagram illustrating an example of the 1x conversion table 63. The 1x conversion table 63 illustrated in FIG. 7 manages a 10-bit IF-AMP control value 63B and a 2-bit RF-AMP control value 63C for each 1x transmission power value 63A. The 1x transmission controller 62 acquires the IF-AMP control value 63B and the RF-AMP control value 63C corresponding to the acquired 1x transmission power value from the 1x conversion table 63. The 1x transmission controller 62 then sets the acquired IF-AMP control value 63B in the IF-AMP 54 and sets the acquired RF-AMP control value 63C in the RF-AMP 56. For example, when the 1x transmission controller 62 sets the IF-AMP control value 63B to “532” and the RF-AMP control value 63C to “2”, the 1x transmission power value becomes 21 dBm. Furthermore, the 1x transmission controller 62 notifies the SAR controller 32 of the 1x transmission power value.

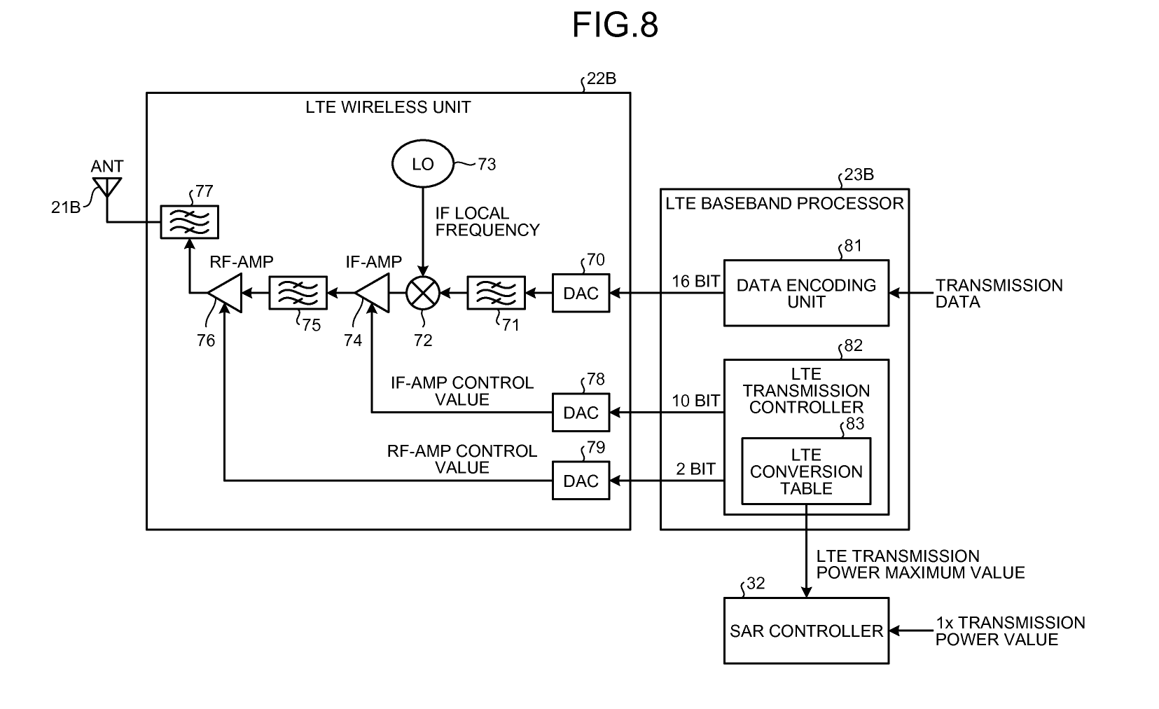

FIG. 8 is an explanatory diagram illustrating an example of the LTE device 12. The LTE device 12 illustrated in FIG. 8 includes the LTE wireless unit 22B and the LTE baseband processor 23B. The LTE wireless unit 22B includes a first DAC 70, a first filter 71, a mixer 72, a local oscillator 73, an IF-AMP 74, a second filter 75, an RF-AMP 76, and a third filter 77. The LTE baseband processor 23B also includes a second DAC 78 and a third DAC 79.

The first DAC 70 converts encoded LTE transmission data to an analog transmission signal. The first filter 71 performs a filtering process on an LTE baseband signal being the analog-converted transmission signal. The mixer 72 generates an LTE-IF signal obtained by mixing the LTE baseband signal and an LTE carrier frequency sent from the local oscillator 73. The IF-AMP 74 amplifies the generated LTE-IF signal. The second filter 75 performs a filtering process on the LTE-IF signal amplified by the IF-AMP 74. The RF-AMP 76 amplifies the RF signal of the LTE-IF signal on which the filtering process is performed. The third filter 77 performs a filtering process on the RF signal.

The LTE baseband processor 23B includes a data encoding unit 81 that encodes LTE transmission data and an LTE transmission controller 82 that controls transmission power of the LTE wireless unit 22B. The LTE transmission controller 82 controls gains of the IF-AMP 74 and the RF-AMP 76 in the LTE baseband processor 23B, and thereby controls the transmission power of the LTE wireless unit 22B. The LTE transmission controller 82 acquires an LTE transmission power maximum value from the SAR controller 32 in the CPU. The LTE transmission controller 82 acquires the LTE transmission power maximum value, and acquires a control value (10-bit IF-AMP control value) of the IF-AMP 74 and a control value (2-bit RF-AMP control value) of the RF-AMP 76, which correspond to the LTE transmission power maximum value, from an LTE conversion table 83.

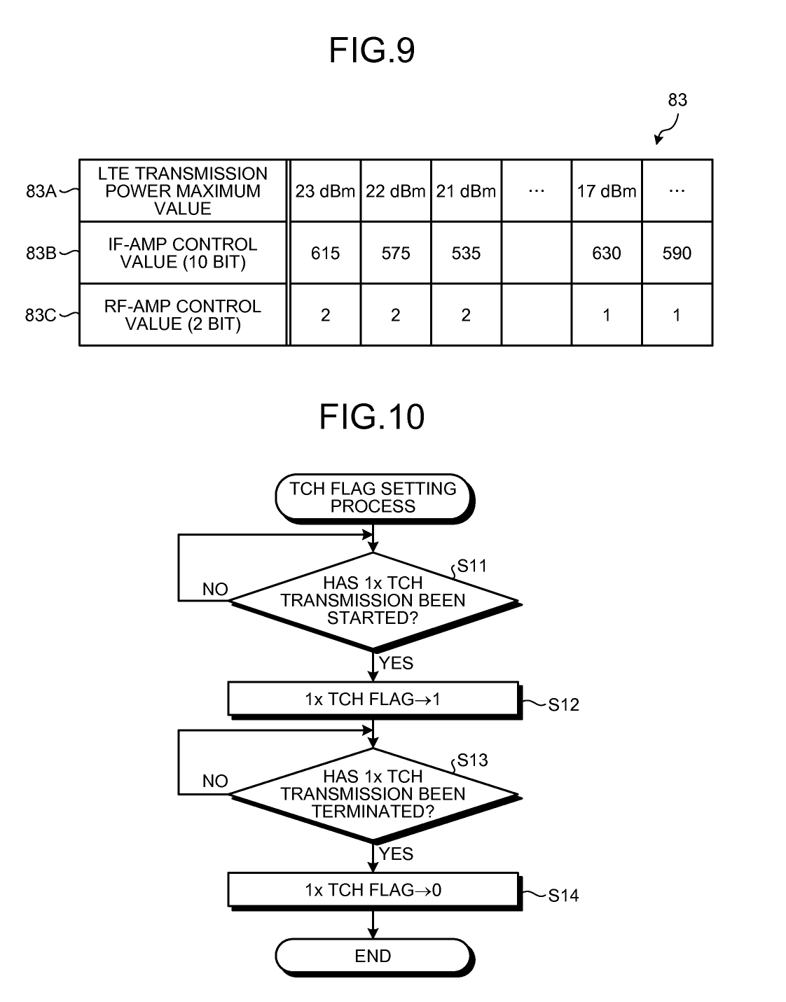

FIG. 9 is an explanatory diagram illustrating an example of the LTE conversion table 83. The LTE conversion table 83 illustrated in FIG. 9 manages a 10-bit IF-AMP control value 83B and a 2-bit RF-AMP control value 83C for each LTE transmission power maximum value 83A. The LTE transmission controller 82 acquires the IF-AMP control value 83B and the RF-AMP control value 83C corresponding to the acquired LTE transmission power maximum value 83A from the LTE conversion table 83. The LTE transmission controller 82 then sets the acquired IF-AMP control value 83B as an upper limit of the IF-AMP 74 and sets the acquired RF-AMP control value 83C as an upper limit of the RF-AMP 76. For example, when the LTE transmission power maximum value 83A is 22 dBm, the LTE transmission controller 82 sets the RF-AMP control value 83C to “2” or less and the IF-AMP control value 83B to “575” or less.

An operation of the multi-wireless terminal 1 according to the first embodiment will be explained below. FIG. 10 is a flowchart illustrating an example of a processing operation of the CPU 19 in the multi-wireless terminal 1 related to a TCH flag setting process. The TCH flag setting process illustrated in FIG. 10 is a process for setting a TCH flag according to a result of monitoring a protocol state for the 1x communication. As illustrated in FIG. 10, the 1x protocol processor 31 in the CPU 19 determines whether 1x TCH transmission has been started (Step S11). When 1x TCH transmission has been started (Yes at Step S11), the 1x protocol processor 31 determines that the protocol state is during 1x TCH transmission, and sets the 1x TCH flag to “1” (Step S12).

The 1x protocol processor 31 sets the 1x TCH flag to “1” and then determines whether the 1x TCH transmission has been terminated (Step S13). When the 1x TCH transmission has been terminated (Yes at Step S13), the 1x protocol processor 31 determines that the protocol state is any state other than during the 1x TCH transmission, sets the 1x TCH flag to “0” (Step S14), and ends the processing operation illustrated in FIG. 10.

When the 1x TCH transmission has not been started (No at Step S11), the 1x protocol processor 31 proceeds to Step S11 to determine whether the 1x TCH transmission has been started. When the 1x TCH transmission has not been terminated (No at Step S13), the 1x protocol processor 31 proceeds to Step S13.

When the 1x TCH transmission has been started, the 1x protocol processor 31 that performs the TCH flag setting process illustrated in FIG. 10 sets the 1x TCH flag to “1”. As a result, when the 1x TCH flag is “1”, the SAR controller 32 can determine that the protocol state of the 1x communication is during the 1x TCH transmission.

When the 1x TCH transmission has been terminated, the 1x protocol processor 31 sets the 1x TCH flag to “0”. As a result, when the 1x TCH flag is “0”, the SAR controller 32 can determine that the protocol state of the 1x communication is any state other than during the 1x TCH transmission.

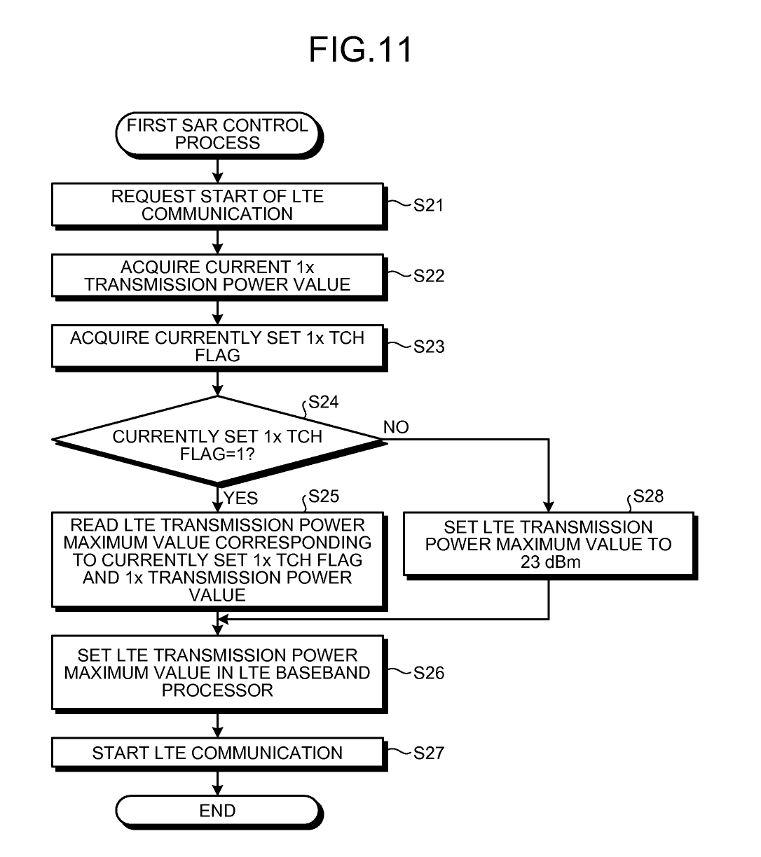

FIG. 11 is a flowchart illustrating an example of a processing operation of the CPU 19 in the multi-wireless terminal 1 related to a first SAR control process. The first SAR control process illustrated in FIG. 11 is a process for setting an LTE transmission power maximum value on the LTE baseband processor 23B side based on the setting result of the 1x TCH flag.

As illustrated in FIG. 11, the SAR controller 32 in the CPU 19 requests start of LTE communication (Step S21). The SAR controller 32 acquires a current 1x transmission power value from the 1x baseband processor 23A (Step S22). The SAR controller 32 acquires a currently set 1x TCH flag from the 1x protocol processor 31 (Step S23), and determines whether the currently set 1x TCH flag is “1” (Step S24).

When the currently set 1x TCH flag is “1” (Yes at Step S24), the SAR controller 32 determines that the protocol state of the 1x system is during the 1x TCH transmission, and refers to the conversion table 40 in FIG. 5. Moreover, the SAR controller 32 refers to the conversion table 40 to read the LTE transmission power maximum value corresponding to the 1x transmission power value (Step S25). The SAR controller 32 sets the acquired LTE transmission power maximum value in the LTE baseband processor 23B (Step S26), starts the LTE communication (Step S27), and ends the processing operation illustrated in FIG. 11. When the conversion table 40 in FIG. 5 is referred to and the LTE transmission power maximum value 42 corresponding to the 1x transmission power value 41 is set in the LTE baseband processor 23B, the SAR controller 32 performs the maximum value control based on the set LTE transmission power maximum value.

When the currently set 1x TCH flag is not “1” (No at Step S24), the SAR controller 32 determines that it is “0”. When the 1x TCH flag is “0”, the SAR controller 32 sets the LTE transmission power maximum value to a fixed value of 23 dBm (Step S28), and proceeds to Step S26 to set the LTE transmission power maximum value in the LTE baseband processor 23B. When a fixed value of 23 dBm has been set as the LTE transmission power maximum value in the LTE baseband processor 23B, the SAR controller 32 stops the maximum value control.

When the currently set 1x TCH flag is “1”, the SAR controller 32 that performs the first SAR control process illustrated in FIG. 11 sets the LTE transmission power maximum value corresponding to the current 1x transmission power value in the LTE baseband processor 23B. Moreover, the SAR controller 32 performs the maximum value control based on the set LTE transmission power maximum value. As a result, when the protocol state of the 1x system is during the 1x TCH transmission, the CPU 19 performs the maximum value control and can thereby limit the LTE transmission power value based on the SAR specifications.

When the currently set 1x TCH flag is “0”, the SAR controller 32 sets the LTE transmission power maximum value as a fixed value of 23 dBm in the LTE baseband processor 23B. Moreover, the SAR controller 32 stops the maximum value control. As a result, when the protocol state of the 1x system is any state other than during the 1x TCH transmission, the CPU 19 stops the maximum value control instead of uniformly performing the maximum value control, and can thereby reduce degradation of an LTE communication throughput due to the SAR specifications.

When the currently set 1x TCH flag is “0”, the CPU 19 according to the first embodiment sets the LTE transmission power maximum value as a fixed value of 23 dBm in the LTE baseband processor 23B, and stops the maximum value control. As a result, when the protocol state of the 1x system is any state other than during the 1x TCH transmission, the CPU 19 stops the maximum value control instead of uniformly performing the maximum value control, and can thereby reduce degradation of the LTE communication throughput due to the SAR specifications.

when detecting that the state is during idle or during position registration operation for a 1x base station 201 through the 1x protocol processor 31, the CPU 19 determines that the protocol state of the 1x system is any state other than during the 1x TCH transmission. As a result, when the protocol state of the 1x system is during idle or during position registration operation, the CPU 19 stops the maximum value control instead of uniformly performing the maximum value control, and can thereby reduce degradation of the LTE communication throughput due to the SAR specifications.

When the 1x TCH flag is “1”, the CPU 19 acquires a current 1x transmission power value, and refers to the conversion table 40 that stores therein LTE transmission power maximum values corresponding to 1x transmission power values to set the LTE transmission power maximum value corresponding to the current 1x transmission power value. Moreover, the CPU 19 performs the maximum value control for limiting the LTE transmission power value based on the set LTE transmission power maximum value. As a result, when the protocol state of the 1x system is during the 1x TCH transmission, the CPU 19 performs the maximum value control and can thereby limit the LTE transmission power value based on the SAR specifications.

The first embodiment is configured to set an LTE transmission power maximum value corresponding to the 1x transmission power value according to the SAR specifications based on the set contents of the 1x TCH flag and perform the maximum value control based on the set LTE transmission power maximum value. However, the SAR specifications differ depending on the destination country. Therefore, the multi-wireless terminal that implements maximum value control according to a destination country will be explained below as a second embodiment. The same signs are assigned to the same components as these in the multi-wireless terminal 1 illustrated in FIG. 1, and explanations of the overlapping components and operations are therefore omitted.

### [b] Second Embodiment

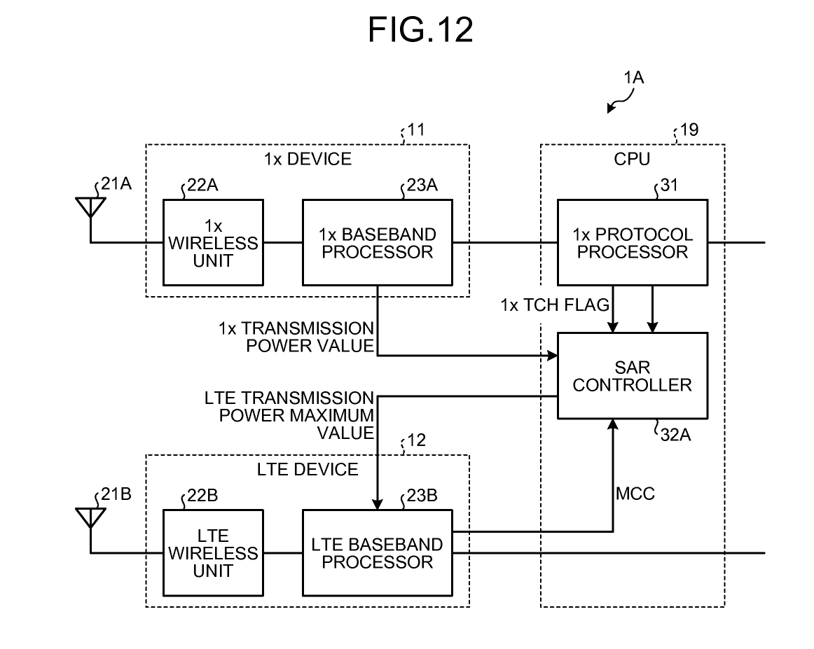

FIG. 12 is an explanatory diagram illustrating examples of the 1x device 11, the LTE device 12, and the CPU 19 in a multi-wireless terminal 1A according to a second embodiment. The multi-wireless terminal 1A illustrated in FIG. 12 includes the 1x device 11, the LTE device 12, and the CPU 19. The LTE baseband processor 23B in the LTE device 12 acquires a Mobile Country Code (MCC) from a Public Land Mobile Network (PLMN) code included in an LTE received signal. The CPU 19 can recognize current country information based on the MCC.

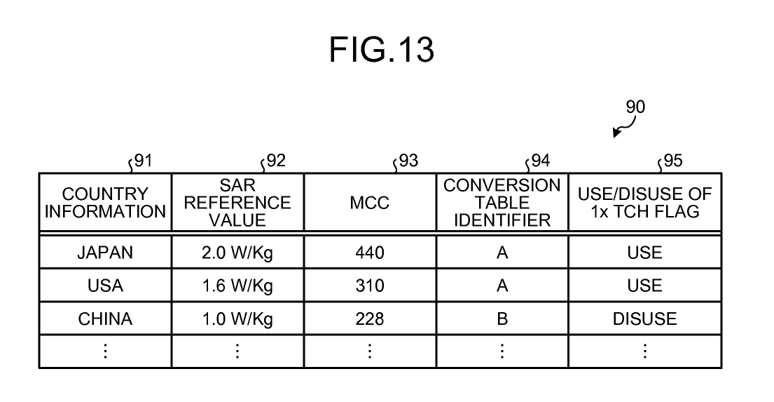

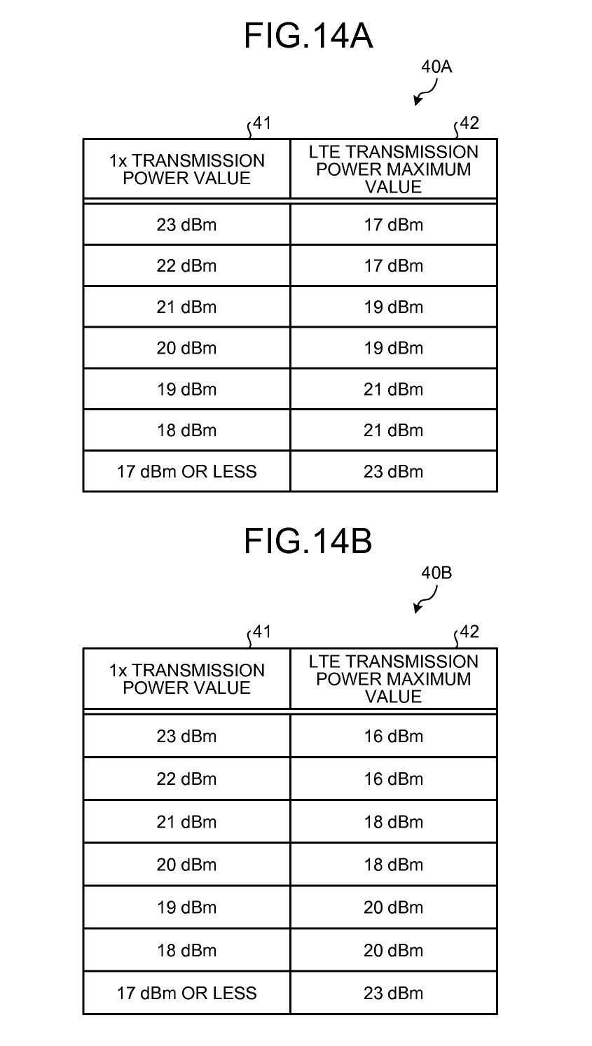

An SAR controller 32A in the CPU 19 acquires a 1x transmission power value from the 1x baseband processor 23A and also acquires a 1x TCH flag from the 1x protocol processor 31. Moreover, the SAR controller 32A acquires MCC from the LTE baseband processor 23B. FIG. 13 is an explanatory diagram illustrating an example of a country-specific setting table. A country-specific setting table 90 manages SAR reference value 92, MCC 93, conversion table identifier 94, and use/disuse of 1x TCH Flag 95, which are associated with one another for each country information 91. When MCC is acquired, the SAR controller 32A refers to the country-specific setting table 90 of FIG. 13 to read conversion table identifier 94 and use/disuse of 1x TCH Flag 95 corresponding to the MCC. For example, when the acquired MCC is “440” that indicates Japan, the SAR controller 32A uses a conversion table 40A as “A” and also uses the 1x TCH flag. For example, when the acquired MCC is “310” that indicates USA, the SAR controller 32A uses the conversion table 40A as “A” and also uses the 1x TCH flag. For example, when the acquired MCC is “228” that indicates China, the SAR controller 32A uses a conversion table 40B as “B” but does not use the 1x TCH flag. FIG. 14A is an explanatory diagram illustrating an example of the conversion table 40A as “A”. The conversion table 40A as “A” illustrated in FIG. 14A is a table in which the 1x transmission power value 41 and the LTE transmission power maximum value 42 are managed in association with each other based on, for example, the SAR standards of Japan and USA. FIG. 14B is an explanatory diagram illustrating an example of the conversion table 40B as “B”. The conversion table 40B as “B” illustrated in FIG. 14B is a table in which the 1x transmission power value 41 and the LTE transmission power maximum value 42 are managed in association with each other based on, for example, the SAR standard of China.

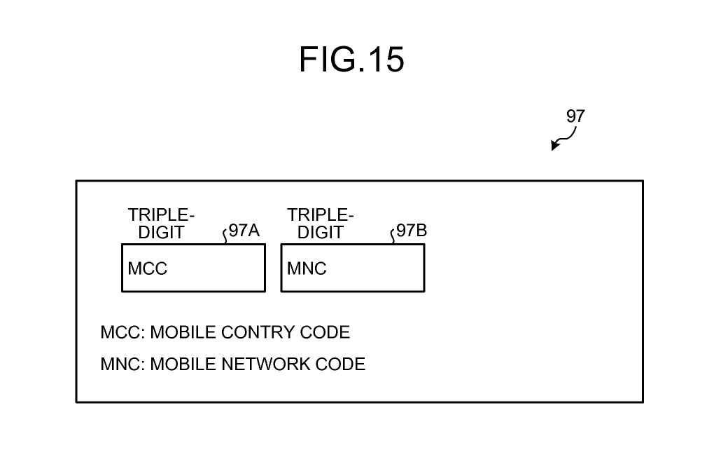

The SAR controller 32A in the CPU 19 acquires a PLMN code from an LTE received signal. FIG. 15 is an explanatory diagram illustrating an example of a PLMN code. A PLMN code 97 illustrated in FIG. 15 includes a triple-digit MCC 97A and a triple-digit MNC (Mobile Network Code) 97B.

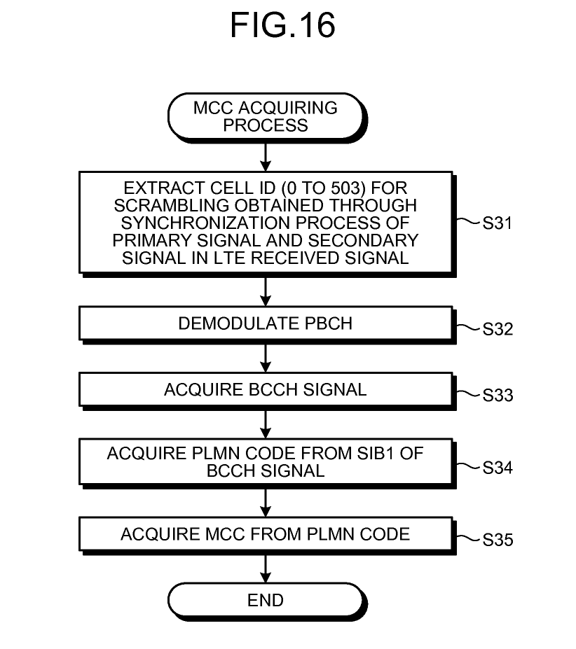

An operation of the multi-wireless terminal 1A according to the second embodiment will be explained below. FIG. 16 is a flowchart illustrating an example of a processing operation of the LTE baseband processor 23B in the multi-wireless terminal 1A related to an MCC acquiring process. The MCC acquiring process illustrated in FIG. 16 is a process for acquiring MCC from an LTE received signal.

As illustrated in FIG. 16, the LTE baseband processor 23B extracts a cell ID (0 to 503) for scrambling obtained through a synchronization process of a primary signal and a secondary signal from the LTE received signal (Step S31). The LTE baseband processor 23B demodulates Physical Broadcast Channel (PBCH) from the received signal based on the acquired cell ID (Step S32).

The LTE baseband processor 23B demodulates the PBCH and acquires a BCCH (Broadcasting Control Channel) signal (Step S33). The LTE baseband processor 23B acquires a PLMN code from System Information Block 1 (SIB1) of the acquired BCCH signal (Step S34). The LTE baseband processor 23B then acquires MCC from the acquired PLMN code (Step S35), and ends the processing operation illustrated in FIG. 16.

The LTE baseband processor 23B that performs the MCC acquiring process illustrated in FIG. 16 acquires MCC in the PLMN code from the LTE received signal. The LTE baseband processor 23B can determine a current country based on the MCC.

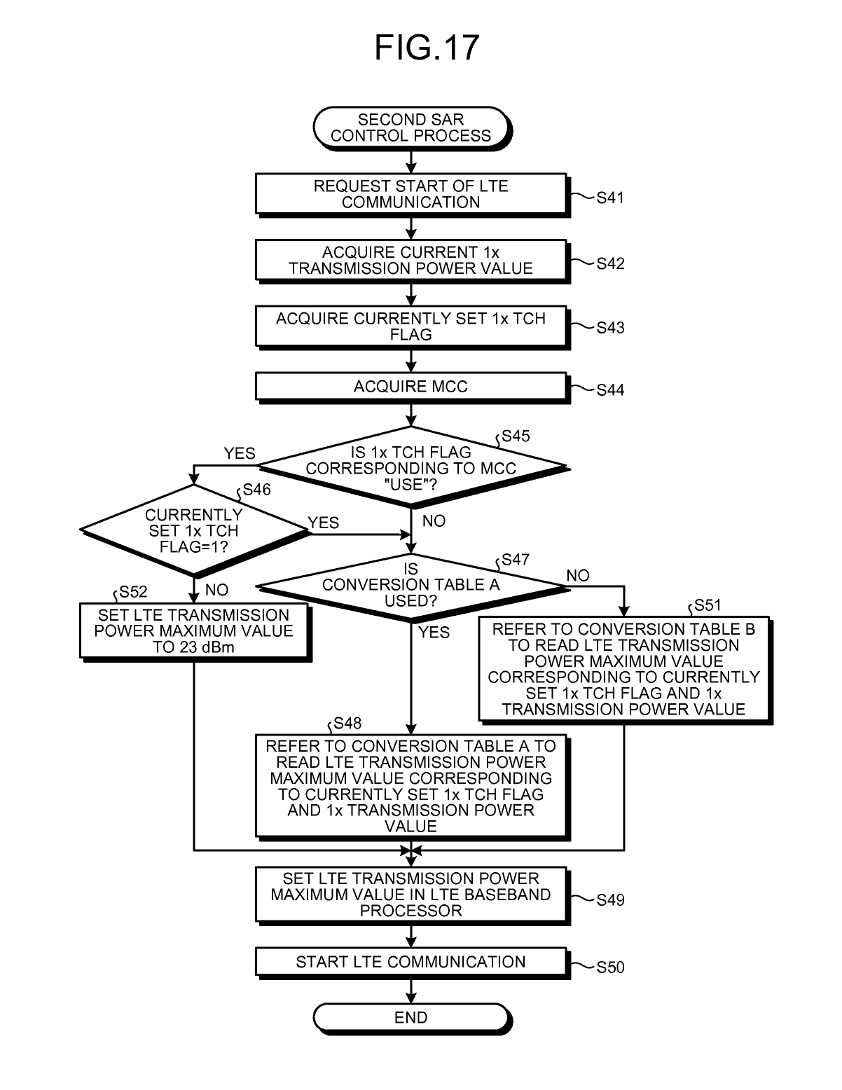

FIG. 17 is a flowchart illustrating an example of a processing operation of the CPU 19 in the multi-wireless terminal 1A related to a second SAR control process. The second SAR control process illustrated in FIG. 17 is a process for setting an LTE transmission power maximum value on the LTE baseband processor 23B side based on the MCC acquired through the LTE received signal and the setting result of the 1x TCH flag.

As illustrated in FIG. 17, the SAR controller 32A in the CPU 19 requests start of LTE communication (Step S41). The SAR controller 32A acquires a current 1x transmission power value from the 1x baseband processor 23A (Step S42). The SAR controller 32A acquires a currently set 1x TCH flag from the 1x baseband processor 23A (Step S43). Moreover, the SAR controller 32A acquires MCC through the MCC acquiring process (Step S44). The SAR controller 32A refers to the country-specific setting table 90 of FIG. 13 to determine whether the 1x TCH flag corresponding to the acquired MCC is “Use” (Step S45). When the 1x TCH flag is “Use” (Yes at Step S45), then the SAR controller 32A determines whether the currently set 1x TCH flag is “1” (Step S46).

When the currently set 1x TCH flag is “1” (Yes at Step S46), then the SAR controller 32A determines that the protocol state of the 1x system is during the 1x TCH transmission. Moreover, the SAR controller 32A determines whether the conversion table 40A as “A” is used based on the conversion table identifier 94 (Step S47). When the conversion table 40A as “A” is used (Yes at Step S47), then the SAR controller 32A refers to the conversion table 40A as “A” to read an LTE transmission power maximum value corresponding to the currently set 1x TCH flag and the 1x transmission power value (Step S48).

The SAR controller 32A sets the read LTE transmission power maximum value in the LTE baseband processor 23B (Step S49), starts the LTE communication (Step S50), and ends the processing operation illustrated in FIG. 17. When the conversion table 40A as “A” is not used (No at Step S47), the SAR controller 32A determines that the conversion table 40B as “B” is used, and refers to the conversion table 40B as “B”. Moreover, the SAR controller 32A reads an LTE transmission power maximum value corresponding to the currently set 1x TCH flag and the 1x transmission power value (Step S51) and proceeds to Step S49 to set the LTE transmission power maximum value.

When the 1x TCH flag corresponding to the MCC is not “Use” (No at Step S45), the SAR controller 32A proceeds to Step S47 to determine whether the conversion table 40A as “A” is used. When the currently set 1x TCH flag is not “1” (No at Step S46), the SAR controller 32A determines that the 1x TCH flag is “0”, and determines that the protocol state of the 1x system is any state other than during the TCH transmission. The SAR controller 32A sets the LTE transmission power maximum value to a fixed value of 23 dBm (Step S52), and proceeds to Step S49 to set the LTE transmission power maximum value in the LTE baseband processor 23B. When a fixed value of 23 dBm is set as the LTE transmission power maximum value in the LTE baseband processor 23B, the SAR controller 32A stops the maximum value control.

When the currently set 1x TCH flag is “1” and the MCC has been acquired, the SAR controller 32A that performs the second SAR control process illustrated in FIG. 17 sets the LTE transmission power maximum value corresponding to the current 1x transmission power value and the MCC in the LTE baseband processor 23B. Moreover, the SAR controller 32 performs the maximum value control based on the set LTE transmission power maximum value. As a result, when the protocol state of the 1x system is during the 1x TCH transmission, the CPU 19 performs the maximum value control and can thereby limit the LTE transmission power value based on the SAR specifications in each country.

When the currently set 1x TCH flag is “0”, the SAR controller 32A sets the LTE transmission power maximum value as a fixed value of 23 dBm in the LTE baseband processor 23B. Moreover, the SAR controller 32A stops the maximum value control. As a result, when the protocol state of the 1x system is any state other than during the 1x TCH transmission, the CPU 19 stops the maximum value control instead of uniformly performing the maximum value control, and can thereby reduce degradation of the LTE communication throughput due to the SAR specifications.

The CPU 19 according to the second embodiment acquires MCC from the LTE received signal and refers to the country-specific setting table 90 to set the LTE transmission power maximum value in the LTE baseband processor 23B according to the acquired MCC. Moreover, the CPU 19 performs the maximum value control for limiting the LTE transmission power value based on the set LTE transmission power maximum value. As a result, the CPU 19 performs the maximum value control based on the SAR specifications according to the current country.

When the current country uses the 1x TCH flag and if the currently set 1x TCH flag is “0”, the CPU 19 sets the LTE transmission power maximum value as a fixed value of 23 dBm in the LTE baseband processor 23B, and stops the maximum value control. As a result, when the protocol state of the 1x system is any state other than during the 1x TCH transmission, the CPU 19 stops the maximum value control instead of uniformly performing the maximum value control, and can thereby reduce degradation of the LTE communication throughput due to the SAR specifications.

The CPU 19 according to the second embodiment is configured to use two types of conversion tables 40A as “A” and 40B as “B” according to the destination country; however, the type is not limited to the two types, and therefore the conversion table 40 may be prepared for each destination country.

Although the CPU 19 acquires MCC in the PLMN code from the LTE received signal, the CPU 19 may acquire, for example, country information obtained from a 1x or EV-DO received signal.

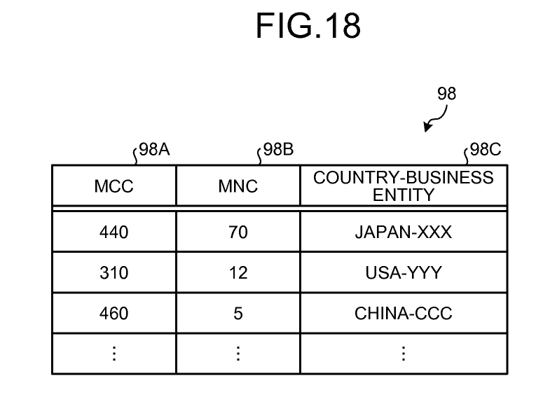

The CPU 19 acquires MCC from the LTE received signal and selects the conversion table 40 according to the MCC. However, the CPU 19 may select the conversion table 40 according to both the MCC and the MNC, instead of only the MCC, i.e. according to the country and the business entity. FIG. 18 is an explanatory diagram illustrating an example of a country-specific/business entity-specific setting table. A setting table 98 illustrated in FIG. 18 manages MCC 98A, MNC 98B, and Country-Business Entity 98C in association with each other. The LTE baseband processor 23B in the CPU 19 acquires a PLMN code from the LTE received signal. The CPU 19 acquires MCC and MNC from the PLMN code, and refers to table contents of the setting table 98 in FIG. 18 to recognize country information and business entity information based on the MCC and the MNC. The SAR controller 32A then selects the conversion table 40 according to the recognized country information and business entity information. This enables the user to automatically select the conversion table 40 based on the SAR specifications corresponding to the country information and the business entity information.

In the embodiment, the multi-wireless terminal 1 such as a smartphone has been exemplified; however, any wireless terminal with, for example, communication functions of the 1x system and the LTE system can be applied.

In the embodiment, the multi-wireless terminal 1 with the communication function of the LTE system has been exemplified; however, the same effect can be obtained even if a Wi-MAX system is applied instead of the LTE system.

The illustrated components of the units do not need to be configured as physically illustrated ones. In other words, specific configurations of distribution and integration of the units are not limited to these as illustrated. Therefore, the whole of or part of the units can be configured by being functionally or physically distributed or integrated by any units according to various loads and use statuses, and the like.

The whole of or any part of the various processing functions performed by the devices may be performed on a central processing unit (CPU) (or a microcomputer such as a micro processing unit (MPU) and a micro controller unit (MCU)). It goes without saying that the whole of or any part of the various processing functions may be performed on the program analyzed and executed by the CPU (or a microcomputer such as MPU and MCU) or on hardware by wired logic.

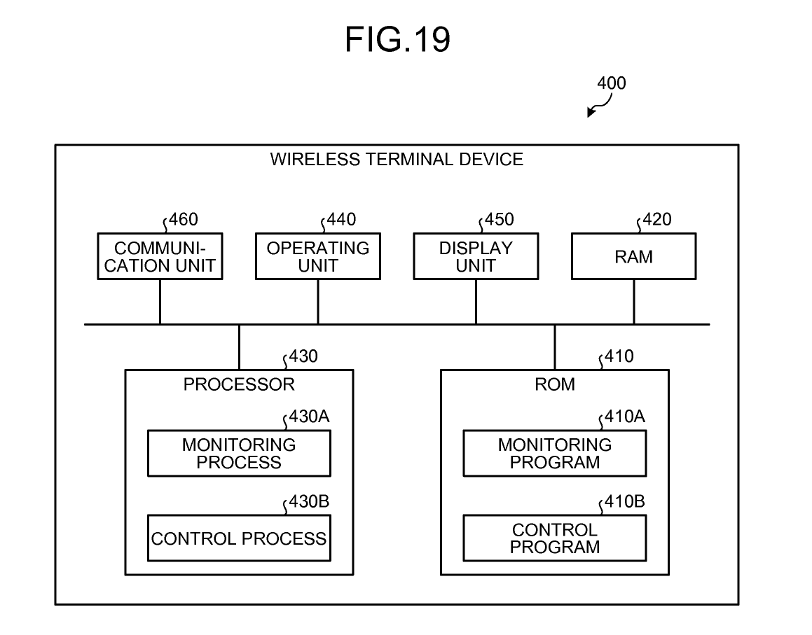

Incidentally, the various processes explained in the present embodiment can be implemented by the wireless terminal device executing the previously prepared programs. Therefore, an example of the wireless terminal device that executes a program having the same function as that of the embodiment will be explained below. FIG. 19 is an explanatory diagram illustrating a wireless terminal device 400 that executes a control program.

As illustrated in FIG. 19, the wireless terminal device 400 that executes the control program includes ROM 410, RAM 420, a processor 430, an operating unit 440, a display unit 450, and a communication unit 460.

A control program implementing the same function as that of the embodiment is previously stored in the ROM 410. The control program may be recorded in a drive (not illustrated)-readable recording medium, instead of the ROM 410. The recording medium may be a portable recording medium such as CD-ROM, a DVD disc, a USB memory, and an SD card, and a semiconductor memory such as a flash memory. The control program includes a monitoring program 410A and a control program 410B as illustrated in FIG. 19. The programs 410A and 410B may appropriately be integrated or distributed.

The processor 430 reads the programs 410A and 410B from the ROM 410, and executes the read programs. The processor 430 functions the programs 410A and 410B as a monitoring process 430A and a control process 430B respectively.

The wireless terminal device 400 allows simultaneous wireless communication for the 1x communication and the LTE communication. The processor 430 monitors the protocol state of the 1x communication. When the protocol state of the 1x communication is during transmission, the processor 430 performs the maximum value control for limiting the transmission power value of the LTE communication. Moreover, when the protocol state of the 1x communication is any state other than during transmission, the processor 430 stops the maximum value control. This enables degradation of the LTE communication throughput due to the SAR specifications to be reduced.

In the disclosed aspects, the degradation of the LTE communication throughput due to the SAR specifications can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless terminal device that allows simultaneous wireless communication for communication of a first communication system and communication of a second communication system, the wireless terminal device comprising:
a memory; and
a processor coupled to the memory, wherein the processor performs a process comprising:
monitoring a protocol state for the communication of the first communication system;
performing maximum value control for limiting a maximum value of transmission power for the communication of the second communication system when the protocol state for the communication of the first communication system is during transmission; and
stopping the maximum value control when the protocol state for the communication of the first communication system is any state other than during the transmission.

2. The wireless terminal device according to claim 1, wherein the stopping the maximum value control includes determining, when detecting that the state is either one of states, during idle and during position registration, of a base station for the communication of the first communication system, that the protocol state for the communication of the first communication system is any state other than during the transmission.

3. The wireless terminal device according to claim 1, wherein the performing the maximum value control includes:
acquiring a current transmission power value related to the communication of the first communication system when the protocol state for the communication of the first communication system is during the transmission; and
referring to, when acquiring the current transmission power value related to the communication of the first communication system, the memory that stores the maximum value of transmission power for the communication of the second communication system corresponding to the transmission power value related to the communication of the first communication system, setting the maximum value of the transmission power for the communication of the second communication system corresponding to the current transmission power value related to the communication of the first communication system, and performing the maximum value control based on the set maximum value.

4. The wireless terminal device according to claim 1, wherein the first communication system is a 1x system and the second communication system is an LTE system.

5. The wireless terminal device according to claim 1, wherein the performing the maximum value control includes:
acquiring country information from a wireless signal for the communication of the second communication system or for the communication of the first communication system; and
referring to, when acquiring the country information, the memory that stores a maximum value of transmission power for the communication of the second communication system for each country information, setting the maximum value of the transmission power for the communication of the second communication system according to the acquired country information, and performing the maximum value control based on the set maximum value.

6. The wireless terminal device according to claim 1, wherein the performing the maximum value control includes:
acquiring country information and business entity information from a wireless signal for the communication of the second communication system or for the communication of the first communication system; and
referring to, when acquiring the country information and the business entity information, the memory that stores the maximum value of the transmission power for the communication of the second communication system for each country information and business entity information, setting the maximum value of the transmission power for the communication of the second communication system according to the acquired country information and business entity information, and performing the maximum value control based on the set maximum value.

7. The wireless terminal device according to claim 1, wherein the communication of the second communication system is used as a substitute for communication of a WiMAX system.

8. A computer-readable recording medium having stored therein a control program of a wireless terminal device that allows simultaneous wireless communication for communication of a first communication system and communication of a second communication system, the program causing the wireless terminal device to execute a process comprising:
monitoring a protocol state for the communication of the first communication system;
performing maximum value control for limiting a maximum value of transmission power for the communication of the second communication system when the protocol state for the communication of the first communication system is during transmission; and
stopping the maximum value control when the protocol state for the communication of the first communication system is any state other than during the transmission.

9. A control method for a wireless terminal device that allows simultaneous wireless communication for communication of a first communication system and communication of a second communication system, the method comprising:
monitoring, using a processor of the wireless terminal device, a protocol state for the communication of the first communication system;
performing, using the processor, maximum value control for limiting a maximum value of transmission power for the communication of the second communication system when the protocol state for the communication of the first communication system is during transmission; and
stopping, using the processor, the maximum value control when the protocol state for the communication of the first communication system is any state other than during the transmission.
